(19) United States
(12) Patent Application Publication
(10) Pub. No.: US 2006/0288795 A1
(43) Pub. Date: Dec. 28, 2006

(54) Strain gage with off axis creep compensation feature

(75) Inventors: Thomas P. Kieffer, Wake Forest, NC (US); Robert B. Watson, Clayton, NC (US); Rebecca L. Showalter, Raleigh, NC (US); Sharon K. Harris, Raleigh, NC (US)

Correspondence Address: MCKEE, VOORHEES & SEASE, P.L.C., 801 GRAND AVENUE, SUITE 3200, DES MOINES, IA, 50309-2721, US

(73) Assignee: Vishay Measurements Group, Inc., Raleigh, NC (US)

(21) Appl. No.: 11/167,397

(22) Filed: Jun. 27, 2005

(51) Int. Cl. G01N 3/00

(52) U.S. Cl. 73/795

(57) ABSTRACT

A strain gage includes a strain gage grid of a conductive foil formed by a plurality of grid lines joined in series by end loops and first and second solder tabs electrically connected to the strain gage grid. The end loops of the strain gage are aligned off-axis with or at an angle relative to the measurement axis of the strain gage to thereby alter creep characteristics of the strain gage.

### BACKGROUND OF THE INVENTION

The present invention relates to strain gages. More particularly, the present invention relates to controlling creep associated with strain gages.

The electrical resistance strain gage or strain gage is typically designed for maximum resistance change due to mechanical strain and minimum change in response to other variables such as temperature. In a typical strain gage, a strain gage grid of foil is bonded to a flexible backing material.

One use of strain gages is in transducers used to sense weight. In the weighing industry, machined structures—termed counter-forces and typically made in high quality tool steel or aluminum—are instrumented with electrical resistance strain gages to form transducers. A weight placed on the counter-force causes a surface strain, which the strain gage senses. When mechanically loaded with a constant weight, all materials suffer a time dependant relaxation, which is termed “creep”. Resulting from creep, strain in the counter-force varies with time, which the strain gage senses, causing an undesirable apparent change in the applied weight.

Strain gages also creep under load, but unlike a transducer counter-force, strain gages can be designed to produce various creep characteristics. The most simple and common method used in prior art for changing the creep characteristics of a strain gage is to alter the end loop length of the strain gage.

Strain gages are commonly employed in the construction of transducers used in the weighing industry. Structures, termed counter-forces, are machined—typically from high quality tool steel or aluminum—and subsequently instrumented with strain gages. When a weight is applied to the counter-force, the strain gage senses the resulting surface strain in the structure and converts it to an electrical signal suitable for use by electronics used to display the value of the applied weight. Both the counter-force material and the strain gage system suffer from a time dependant relaxation termed creep. Creep is a measure of the relaxation of a material or structure loaded by a constant weight. Typically, this relaxation is quantified by monitoring the resulting change in mechanical strain in the structure or material over time at a constant load.

Unlike transducer counter-forces, strain gages can readily be designed to produce different creep characteristics. By properly designing the strain gage, it can compensate for creep in the counter-force, resulting in a quasi-stable display of the applied weight. Prior art has focused primarily on altering the end loop length of the strain gage to control creep of the gage and properly compensate the transducer. While effective, this method of creep adjustment can result in short end loop lengths on high creep, low capacity transducers (typically, less than 300 g). Often, the end loop length can approach the same magnitude as the strain gage grid line width. As the end loop becomes shorter, and certainly as it approaches the same magnitude as the line width, the gage becomes less stable and repeatable in performance.

The metal foil in which the end loop is formed is adhesively joined or bonded to the insulating layer of the strain gage that is adhesively bonded to the counter-force. As the end loop area becomes small, there is little adhesive surface holding the metal end loop to the insulating layer, causing uncertain bond strength and the aforementioned gage instability.

Therefore, the numerous problems remain with strain gages particularly with respect to controlling creep.

### BRIEF SUMMARY OF THE INVENTION

Therefore, it is a primary object, feature, or advantage of the present invention to improve over the state of the art.

It is a further object, feature, or advantage of the present invention to provide for creep correction in strain gages.

A still further object, feature, or advantage of the present invention is to provide for creep correction without needing to reduce end loop area.

Yet another object, feature, or advantage of the present invention is to provide for creep correction without negatively impacting bond strength and strain gage stability.

A further object, feature, or advantage of the present invention is to remove the difficulties associated with selecting an appropriate end loop length in order to control creep.

One or more of these and/or other objects, features, or advantages of the present invention will become apparent from the specification and claims that follow.

According to one aspect of the invention, a strain gage is provided. The strain gage includes a strain gage grid of a conductive foil formed by a plurality of grid lines joined in series by end loops. There is a first solder tab and a second solder tab electrically connected to the strain gage grid. There is a measurement axis associated with the strain gage. The end loops of the strain gage grid are aligned off-axis with the measurement axis to thereby alter creep characteristics of the strain gage. The measurement axis may be defined by an axis of maximum positive strain (tension) or axis of maximum negative strain (compression) which is typically parallel with the strain gage grid lines.

According to another aspect of the invention, a method of providing a strain gage having a strain gage grid of a conductive foil formed of a plurality of grid lines joined in series by end loops is provided. The method includes altering tug force applied to the grid lines by the end loops by varying alignment of the end loops relative to a measurement direction of the strain gage. This varying alignment may be provided while maintaining the length of the end loops as a constant. The alignment can vary including to angles greater than 15 degrees, 30 degrees, 45 degrees, etc.

### BRIEF DESCRIPTION OF THE DRAWINGS

FIG. 1 is a graph showing the effects of creep over time.

FIG. 2 is a view of a prior art embodiment of the end loop of a strain gage.

FIG. 3 is a diagram indicating a strain gage end loop of the present invention.

FIG. 4 is a graph illustrating the relationship between the angle relative to the measurement axis and the end loop tug force.

FIG. 5 is a schematic representing a typical strain distribution on the surface of a transducer counter-force.

FIG. 6A is a top view of a prior art strain gage sensor.

FIG. 6B is a top view of a strain gage sensor according to the present invention having end loops that are angled relative to the measurement axis or off-axis.

### DETAILED DESCRIPTION OF THE PREFERRED EMBODIMENT

The present invention improves on the performance of strain gages during creep correction by utilizing long end loops that are adjusted by angle relative to the measurement axis of the strain gage.

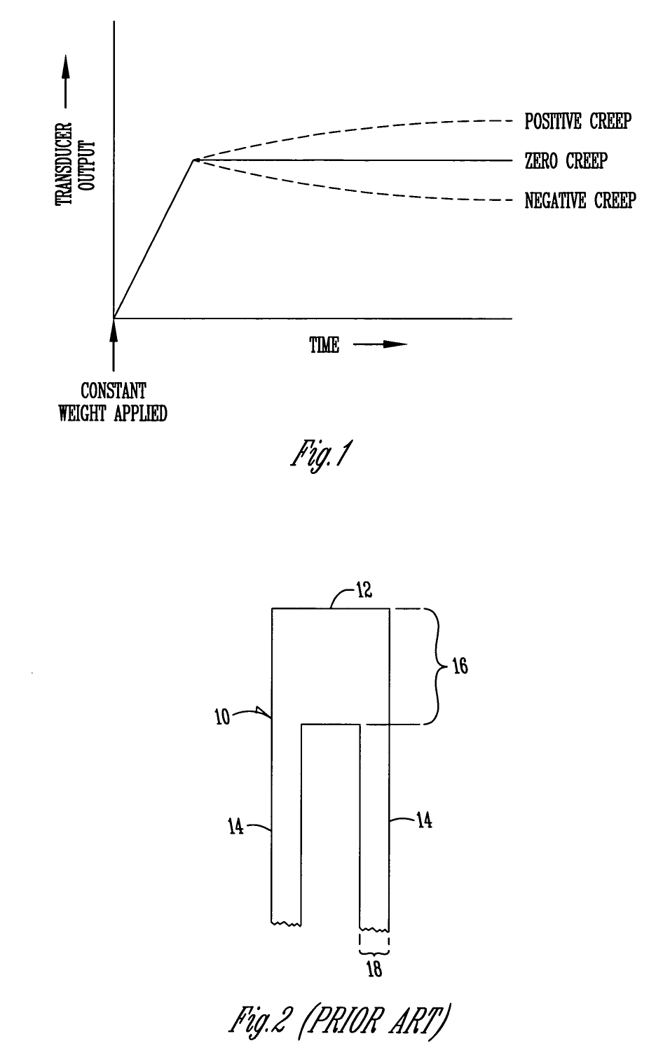

FIG. 1 is a graph showing the output of a transducer over time when a constant weight is applied to the transducer. Although zero creep is ideal, there will typically be either negative creep or positive creep appearing over time.

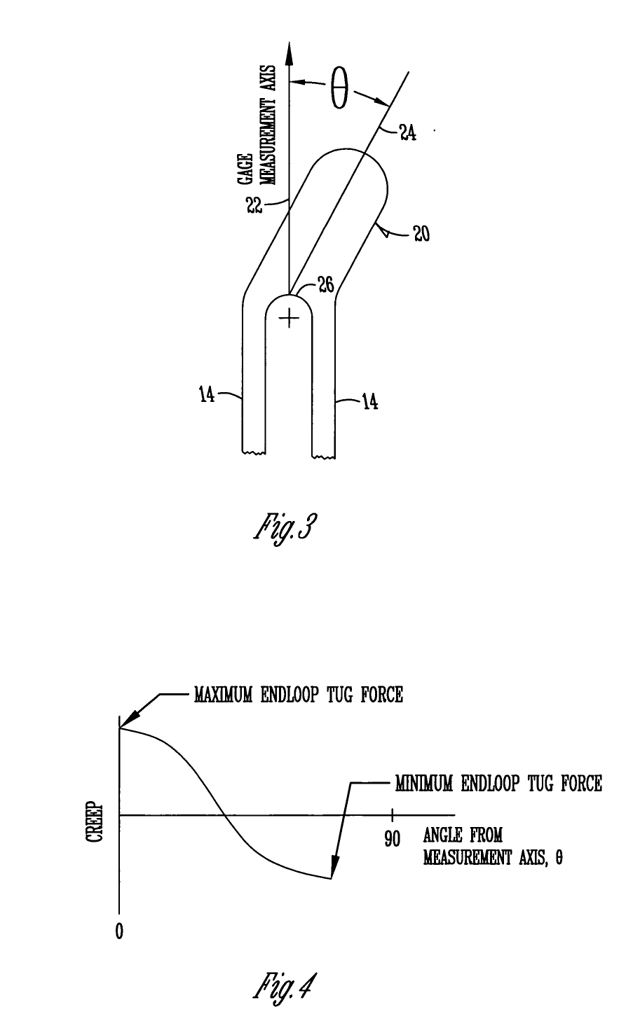

FIG. 2 illustrates one example of a prior art end loop 10. The end loop 10 is used to turn around grid lines 14. The end loop 10 has length 16. The grid lines have a width 18. Strain gages typically include numerous metal traces called grid lines 14 joined by turn-around loops called end loops 10. Each grid line 14 is connected to its immediate neighboring grid line by an end loop 10, forming a sinuous grid pattern. To adjust creep, designers of prior art strain gages vary the length of the end loop 10 by an appropriate amount to properly compensate for creep in the transducer counter-force. The desirable length is typically arrived at through iterative testing of the transducer, altering the subsequent end loop length based upon previous test results. The final optimum length is a function of grid line width 18, counter-force material, transducer capacity, and loading method. As such, it is not possible to accurately calculate a correct length a priori.

FIG. 3 illustrates one embodiment of an end loop 20 of the present invention. Instead of merely adjusting end loop length, the present invention takes advantage of the strain distribution present on the surface of a loaded counter-force and tailors strain gage creep by adjusting end loop angle relative to the measurement axis of the strain gage grid. Note that the end loop 20 is off-axis with the strain gage measurement axis 22 which is generally parallel with the grid lines 14. There is an angle θ between the strain gage measurement axis 22 and the central axis of the end loop 24.

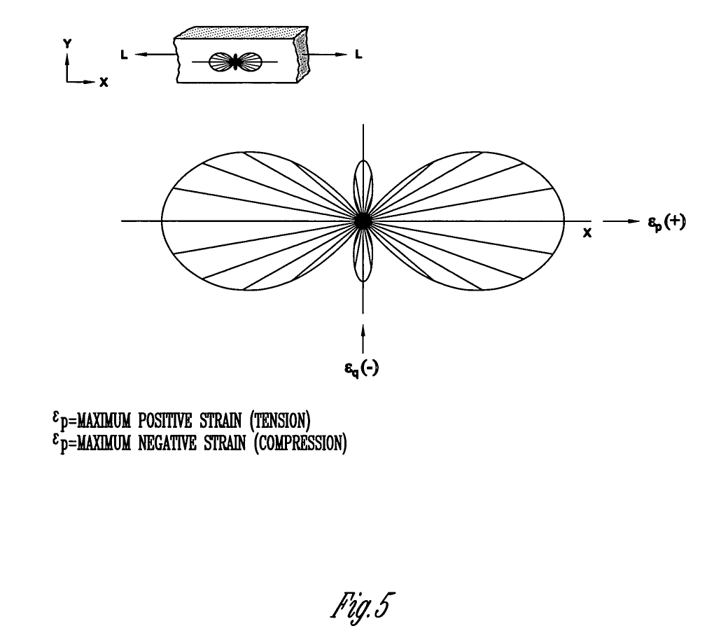

FIG. 4 is a graph showing how the end loop tug force varies with the angle θ between the end loop and the measurement axis. Strain gages respond to surface strain in the structure to which they are bonded. In transducers, this surface strain has a two-dimensional distribution as shown in FIG. 5. As shown in FIG. 5, there is an axis of maximum positive and an axis of maximum negative strain. Normally, the measurement axis of the strain gage—typically, the direction parallel to the grid lines—is aligned in one of these directions on the counter-force.

Altering the tug force applied to the grid lines by the end loops effects creep adjustment in strain gages. In prior art, this force is adjusted by changing the end loop area by adjusting its length. The present invention takes advantage of the two-dimensional state of strain in the counter-force surface as described above and alters the tug force of the end loop by keeping the end loop length constant and varying the alignment of the end loop relative to the measurement direction of the strain gage.

When the end loop angle (θ) is zero (end loop is aligned with the measurement axis of the strain gage), the long end loop length produces a high tug force on the grid line. When θ is greater than zero, the end loop is aligned in a lower strain magnitude direction and the tug force on the grid line is reduced. Keeping the end loop long and, therefore, the bonded area of the end loop large, and adjusting gage creep by altering the angle of the end loop relative to the measurement direction provides for accurate transducer creep compensation and better gage stability and repeatability.

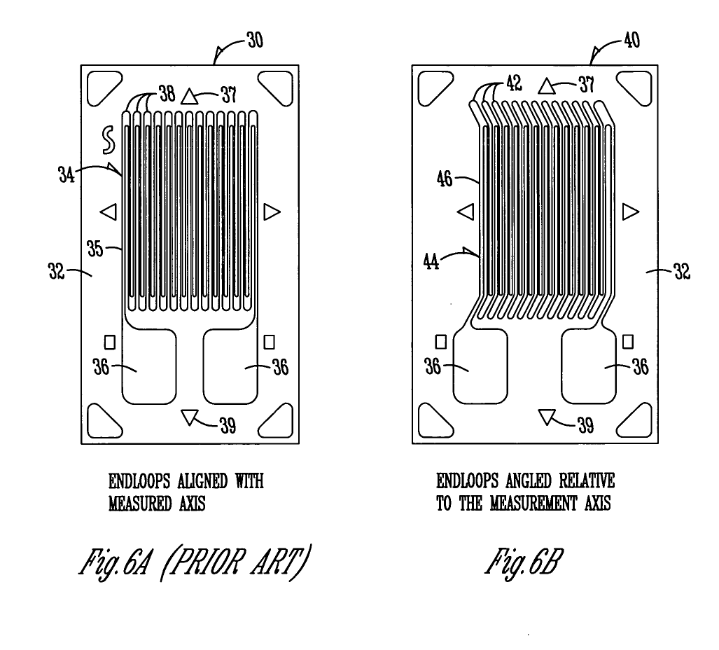

FIG. 6A illustrates a prior art strain gage 30 having an insulating substrate or backing 32 with a strain gage grid 34 formed of a plurality of grid lines 35 and a plurality of end loops 36. Note alignment marks 37 and 39 indicate the direction of the measurement axis. First and second solder tabs 36 are also shown attached to opposite ends of the strain gage grid 34.

FIG. 6B illustrates a strain gage 40 of the present invention. In FIG. 6B, there is a strain gage grid 44 having a plurality of end loops 42, each of which is angled relative to the grid lines 46 and the measurement axis. The alignment marks 37 and 39 indicate the direction of the measurement axis. The present invention contemplates that the grid lines 46 may not always be parallel with the measurement axis. The strain gage grid 44 is bonded to a backing or insulating substrate 32 such as polymide or epoxy. The strain gage grid can be formed of any number of conductive foils, including metal foils of constantan alloys, Karma alloys, isoelastic alloys, platinum tungsten alloys, or other types of conductive foils. Note that in FIG. 5B, the end loops 42 are off-axis. Also, observe that the end loops are not shortened as shown in FIG. 5A.

Therefore a strain gage and a method of designing a strain gage to compensate for creep effects has been disclosed. The present invention contemplates variations in the strain gage including, variations in the resistance characteristics, composition, insulating layer, grid configuration, and other variations within the spirit and scope of the invention.

What is claimed is:

1. A strain gage, comprising:
a strain gage grid of a conductive foil formed by a plurality of grid lines joined in series by end loops;
a first and second solder tab electrically connected to the strain gage grid;
a measurement axis;
wherein the end loops are aligned off-axis with the measurement axis to thereby alter creep characteristics of the strain gage.

2. The strain gage of claim 1 wherein the end loops are aligned off-axis at an angle of θ, relative to the measurement axis and wherein θ is greater than 30 degrees.

3. The strain gage of claim 2 wherein θ is greater than 60 degrees.

4. The strain gage of claim 1 further comprising an insulating layer bonded to the strain gage grid.

5. The strain gage of claim 1 wherein the measurement axis is parallel with the grid lines.

6. The strain gage of claim 1 further comprising markings indicating the measurement axis.

7. A strain gage, comprising:
a strain gage grid of a conductive foil formed by a plurality of grid lines joined in series by end loops;
a first and second solder tab electrically connected to the strain gage grid;
a measurement axis defined by an axis of maximum positive (tension) strain or an axis of maximum negative (compression) strain;
wherein the end loops are aligned at an angle of θ relative to the measurement axis and
wherein θ is greater than 0 degrees.

8. The strain gage of claim 7 wherein θ is greater than 0 and less than 90 degrees.

9. The strain gage of claim 7 wherein θ is less than 30 degrees.

10. The strain gage of claim 7 wherein θ is greater than 45 degrees.

11. The strain gage of claim 7 further comprising an insulating layer bonded to the strain gage grid.

12. The strain gage of claim 11 with bonding adhesive layer thickness between 1 and 50 microns.

13. The strain gage of claim 11 bonded to a transducer counter-force.

14. The strain gage of claim 13 with a bonding adhesive layer thickness between 1 and 50 microns.

15. The strain gage of claim 7 further comprising measurement axis markings.

16. The strain age of claim 7 wherein the measurement axis is parallel with the grid lines.

17. The strain gage of claim 7 further comprising a non-conductive encapsulating layer attached to the strain gage grid.

18. The strain gage of claim 17 further comprising a metallized surface on the encapsulating layer.

19. The strain gage of claim 7 comprising a non-parallel end loop shape.

20. The strain gage of claim 7 comprising asymmetrical end loops.

21. A method of providing a strain gage having a strain gage grid of a conductive foil formed of a plurality of grid lines joined in series by end loops, comprising altering tug force applied to the grid lines by the end loops by varying alignment of the end loops relative to a measurement direction of the strain gage.

22. The method of claim 21 further comprising maintaining length of the end loops as constant.

23. The method of claim 21 wherein the strain gage is a strain gage used in a transducer.

24. The method of claim 21 wherein the alignment of the end loops relative to the measurement direction of the strain gage is defined by an angle θ between the measurement direction and the end loops and wherein θ is greater than 0 and less than 90 degrees.

25. The method of claim 24 wherein θ is greater than 15 degrees.

26. The method of claim 24 wherein θ is greater than 30 degrees.

27. The method of claim 21 wherein the strain gage includes an insulating layer bonded to the strain gage grid.

28. The method of claim 27 with bonding adhesive layer thickness between 1 and 50 microns.

29. The method of claim 27 further comprising bonding the insulating layer to a counter force.

30. The method of claim 29 with a bonding adhesive layer thickness between 1 and 50 microns.

31. The method of claim 29 where the strain gage is used in strain fields produced by direct stress, bending stress, shear stress, or any combination thereof.
